(19) United States
(12) Patent Application Publication
(10) Pub. No.: US 2026/0359253 A1
(43) Pub. Date: Nov. 12, 2026

(54) INTERCONNECT SYSTEM, DEVICE AND NETWORK

(71) Applicant: IEIT SYSTEMS (BEIJING) CO., LTD., Beijing (CN)

(72) Inventors: Jiangwei WANG, Beijing (CN); Jingdong ZHANG, Beijing (CN); Rui HAO, Beijing (CN); Yanwei WANG, Beijing (CN); Linge XIAO, Beijing (CN); Le YANG, Beijing (CN)

(21) Appl. No.: 19/139,823

(22) PCT Filed: Sep. 29, 2024
(86) PCT No.: PCT/CN2024/122115

§ 371 Date: Jun. 16, 2025

(30) Foreign Application Priority Data
Oct. 27, 2023 (CN) 202311413029.8

(51) Int. Cl. G06F 13/42

(52) U.S. Cl. CPC G06F 13/4221; G06F 2213/0026

(57) ABSTRACT

The present disclosure discloses an interconnection system, an interconnection device and an interconnection network. The interconnection system includes an interconnection device and a plurality of hosts. The interconnection device comprises a network interface, a logical interconnection module and a plurality of peripheral component interconnect express (PCIE) interfaces; the network interface is configured to be connected to a master device; any PCIE interface is configured in an end point (EP) mode and connected to one of the plurality of hosts to form a host cluster of mesh topologies or crossbar topologies; and the logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

### CROSS-REFERENCE TO RELATED APPLICATION

The present disclosure claims the priority of Chinese patent application filed on Oct. 27, 2023 before the CNIPA, China National Intellectual Property Administration with the application number of 2023114130298, and the title of “INTERCONNECTION SYSTEM, DEVICE AND NETWORK”, which is incorporated herein in its entirety by reference.

FIELD The present disclosure relates to the field of computer technologies, and more particularly to an interconnection system, an interconnection device and an interconnection network.

### BACKGROUND

At present, interconnection between different host servers is mostly realized through network cards and network cables, and different host servers cannot be directly connected through a hardware network card.

Therefore, how to realize direct connection between different host servers with one hardware device is a problem to be solved by a person skilled in the art.

### SUMMARY

In view of this, the purpose of the present disclosure is to provide an interconnection system, an interconnection device and an interconnection network, so as to realize direct connection between different host servers with one hardware device. The solutions are as follows.

The present disclosure provides an interconnection system, including: an interconnection device and a plurality of hosts, where
the interconnection device includes a network interface, a logical interconnection module and a plurality of peripheral component interconnect express (PCIE) interfaces;
the network interface is configured to be connected to a master device;
any PCIE interface of the plurality of PCIE interfaces is configured in an end point (EP) mode and connected to one of the plurality of hosts to form a host cluster of mesh topologies or a host cluster of crossbar topologies; and
the logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

In an embodiment of the present disclosure, the interconnection device further includes a configuration device, where
the configuration device is configured to configure the host connected to a current PCIE interface and a slave device core of the current PCIE interface according to a configuration message of any PCIE interface.

In an embodiment of the present disclosure, the configuration device is configured to obtain configuration data of the slave device core based on the configuration message and configure the configuration data in the slave device core.

In an embodiment of the present disclosure, the network interface is internally provided with a first register configured to record network protocols supported by the master device; and
the logical interconnection module is further configured to encapsulate the data sent by the host connected to any PCIE interface using the network protocols supported by the master device, and forward encapsulated data to the master device.

In an embodiment of the present disclosure, the network interface is further configured to update the network protocols recorded in the first register according to protocol update information sent by the master device.

In an embodiment of the present disclosure, any PCIE interface is configured in a root port (RP) mode and connected to an accelerator card, where
the logical interconnection module is configured to forward accelerator card data sent by a PCIE interface connected to the accelerator card to the hosts connected to other PCIE interfaces, forward the data sent by the master device to the accelerator card connected to any PCIE interface, and forward the accelerator card data sent by the PCIE interface connected to the accelerator card to the master device.

In an embodiment of the present disclosure, the interconnection device further includes an enabling device, where
the enabling device is configured to disable other PCIE interfaces when enabling the network interface and any PCIE interface.

In an embodiment of the present disclosure, the enabling device is further configured to disable the network interface and other PCIE interfaces when enabling any two PCIE interfaces of the plurality of PCIE interfaces.

In an embodiment of the present disclosure, the logical interconnection module is further configured to encapsulate a network protocol message sent by the master device as a PCIE message and forward the PCIE message to any PCIE interface.

In an embodiment of the present disclosure, the logical interconnection module is further configured to discard data without a forwarding address.

In an embodiment of the present disclosure, the interconnection device further includes a direct memory access (DMA) management device and a DMA controller, where
the DMA management device is configured to query memory idle information of the host connected to any PCIE interface and write data to be transmitted into a memory of a current host in a DMA mode using the DMA controller and the memory idle information.

In an embodiment of the present disclosure, the DMA management device is further configured to broadcast memory information of the interconnection device to the host connected to any PCIE interface.

In an embodiment of the present disclosure, the DMA management device is further configured to store host memory information broadcasted by the host connected to any PCIE interface.

In an embodiment of the present disclosure, the interconnection device includes a field programmable gate array (FPGA) accelerator card, an application specific integrated circuit (ASIC) accelerator card or a multi-core processor.

The present disclosure provides an interconnection device, including: a network interface, a logical interconnection module and a plurality of peripheral component interconnect express (PCIE) interfaces, where
the network interface is configured to be connected to a master device;
any PCIE interface of the plurality of PCIE interfaces is configured in an end point (EP) mode and connected to one of the plurality of hosts to form a host cluster of mesh topologies or a host cluster of crossbar topologies; and
the logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

In an embodiment of the present disclosure, the interconnection device further includes a configuration device, where
the configuration device is configured to configure the host connected to a current PCIE interface and a slave device core of the current PCIE interface according to a configuration message of any PCIE interface.

In an embodiment of the present disclosure, the network interface is internally provided with a first register configured to record network protocols supported by the master device; and
the logical interconnection module is further configured to encapsulate the data sent by the host connected to any PCIE interface using the network protocols supported by the master device, and forward encapsulated data to the master device.

In an embodiment of the present disclosure, any PCIE interface is configured in a root port (RP) mode and connected to an accelerator card, where
the logical interconnection module is configured to forward accelerator card data sent by a PCIE interface connected to the accelerator card to the hosts connected to other PCIE interfaces, forward the data sent by the master device to the accelerator card connected to any PCIE interface, and forward the accelerator card data sent by the PCIE interface connected to the accelerator card to the master device.

The present disclosure provides an interconnection network, including a plurality of interconnection devices as described above.

In an embodiment of the present disclosure, network interfaces of different interconnection devices are connected to a same master device.

As can be seen from the above solutions, the present disclosure provides an interconnection system, including: an interconnection device and a plurality of hosts, where the interconnection device includes a network interface, a logical interconnection module and a plurality of peripheral component interconnect express (PCIE) interfaces; the network interface is configured to be connected to a master device; any PCIE interface of the plurality of PCIE interfaces is configured in an end point (EP) mode and connected to one of the plurality of hosts to form a host cluster of mesh topologies or a host cluster of crossbar topologies; and the logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

It can be seen that the present disclosure has beneficial effects that the interconnection device may directly be connected to the plurality of hosts through its own PCIE interfaces to form the host cluster of mesh topologies or the host cluster of crossbar topologies. Since the PCIE interfaces of the interconnection device are configured in the EP mode, it is possible to use this interconnection device without increasing hardware costs to realize a data path between any host connected to the interconnection device and a network interface of the interconnection device, a data path between the network interface of the interconnection device and a host connected to any PCIE interface of the interconnection device, and a data path between the hosts connected to different PCIE interfaces of the interconnection device, without being connected to different hosts through network cards and networks.

### BRIEF DESCRIPTION OF THE DRAWINGS

In order to more clearly illustrate technical solutions in the embodiments of the present disclosure or in the related art, accompanying drawings to be used in the description of the embodiments or the related art will be briefly introduced below. Obviously, the accompanying drawings in the description below are only some embodiments of the present disclosure. For a person skilled in the art, other accompanying drawings may also be obtained according to the provided accompanying drawings without paying creative labor.

FIG. 1 is a schematic diagram of an interconnection system disclosed in the present disclosure.

FIG. 2 is a schematic diagram of an interconnection network disclosed in the present disclosure.

FIG. 3 is a schematic diagram of another interconnection network disclosed in the present disclosure.

FIG. 4 is a schematic diagram of a Switch function of an interconnection device based on a field programmable gate array (FPGA) disclosed in the present disclosure.

FIG. 5 is a structural diagram of an interconnection device 1 provided by the present disclosure.

FIG. 6 is a structural diagram of an interconnection device 2 provided by the present disclosure.

FIG. 7 is a schematic diagram of another interconnection device provided by the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are merely a part of the embodiments of the present disclosure, rather than all of the embodiments. All of the other embodiments that a person skilled in the art obtains on the basis of the embodiments of the present disclosure without paying creative labor fall within the protection scope of the present disclosure.

At present, interconnection between different host servers is mostly realized through network cards and network cables, and different host servers cannot be directly connected through a hardware network card. Therefore, the present disclosure provides an interconnection solution, which is capable of being directly connected to a plurality of hosts using an interconnection device, so that the plurality of hosts may form a host cluster of mesh topologies or a host cluster of crossbar topologies. In addition, by using the interconnection device, it is possible to realize a data path between any host connected to the interconnection device and a network interface of the interconnection device, a data path between the network interface of the interconnection device and any host connected the interconnection device, and a data path between the hosts connected to different PCIE interfaces of the interconnection device, without being connected to different hosts through network cards and networks.

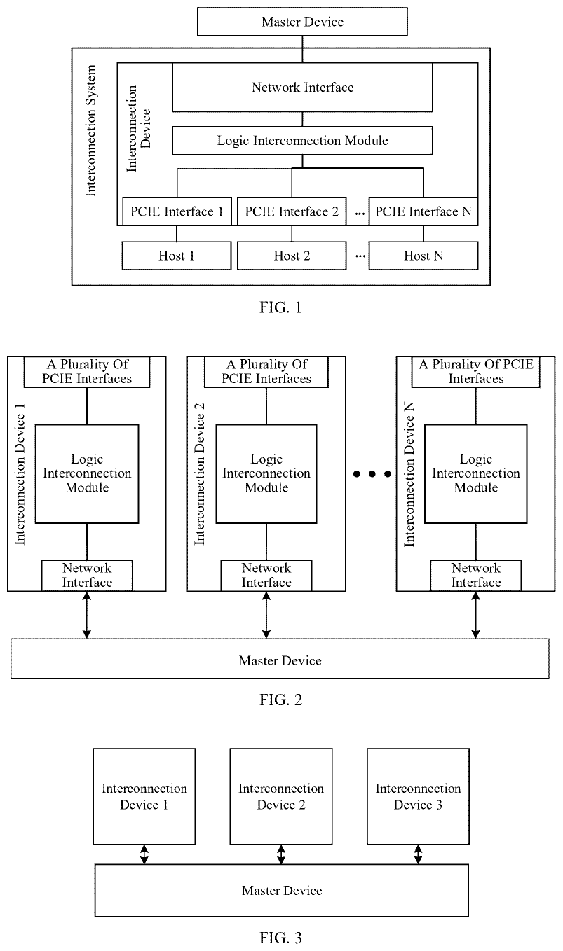

Referring to FIG. 1, an interconnection system disclosed in an embodiment of the present disclosure includes an interconnection device and a plurality of hosts, where the interconnection device includes a network interface, a logical interconnection module and a plurality of peripheral component interconnect express (PCIE) interfaces; the network interface is configured to be connected to a master device; and any PCIE interface of the plurality of PCIE interfaces is configured in an end point (EP) mode and connected to one of the plurality of hosts to form a host cluster of mesh topologies or a host cluster of crossbar topologies. It can be seen that any device with the network interface, the logical interconnection module and the PCIE interfaces configured in the EP mode can be used as the interconnection device provided in this embodiment. The logical interconnection module can be a hardware module with processor functionality.

The logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

In this embodiment, data sent by any host to the interconnection device through the PCIE interface may reach the master device connected to the network interface of the interconnection device. In this embodiment, the data sent by any host to the interconnection device through the PCIE interface may reach the hosts connected to other PCIE interfaces, thereby realizing the data path between the hosts connected to different PCIE interfaces of the interconnection device. In this embodiment, the data sent by the master device to the interconnection device may reach the host connected to any PCIE interface of the interconnection device, thereby realizing the data path between the network interface of the interconnection device and the host connected to any PCIE interface of the interconnection device.

In this embodiment, the master device can be a remote host or a remote acceleration device.

In one embodiment, the interconnection device further includes a configuration device, where the configuration device is configured to configure the host connected to a current PCIE interface and a slave device core of the current PCIE interface according to a configuration message of any PCIE interface. Device number configuration and bus address configuration are performed on the host according to the configuration message.

In one embodiment, the configuration device is configured to obtain configuration data of the slave device core based on the configuration message and configure the configuration data in the slave device core. The interconnection device further includes a bus register and a memory window register. Correspondingly, the configuration device is configured to configure the bus register and the memory window register according to the configuration message to configure a root device core of the PCIE interface; or convert the configuration message into a data format matching the EP mode, and configure a bus address obtained by converting a memory address of the host in the slave device core according to a converted configuration message. The data format matching the EP mode is a type0 format, and data format matching a root port (RP) mode is a type1 format.

An interconnection device includes a plurality of PCIE interfaces, and the configuration of any PCIE interface can be realized by means of configuration devices. The interconnection device includes N PCIE interfaces, so that the data path between any PCIE interface of the interconnection device and the network interface, the data path between the network interface and any PCIE interface and the data path between different PCIE interfaces can be realized without the aid of an expansion controller. Therefore, the interconnection device may support a mesh topology and a crossbar topology to enable the master device and a plurality of hosts to construct a mesh topology and a crossbar topology.

When configuring an internet protocol (IP) address for a PCIE interface, command registers such as an enabling memory space register, an IO space register and a bus master register are configured, and a write maximum load length register, a maximum read request register and a strong sequence mode register are configured. When initializing the PCIE interface, bus registers such as a root bus register, a sub bus register and a maximum bus register are configured; a memory window register is configured to set information such as a range of a memory that may be prefetched by the interface, a window base address of the memory that may not be prefetched, a window size, and the like; and identification information (bus device function (BDF) value) of the host device is configured. At this point, the PCIE interface can realize a Switch function based on a built-in root device core. Generally, a capacity configuration space register of a root port (RP) is in the root port, and a capacity configuration register of a Switch is in the Switch. The BDF value refers to a bus number, a device number and a function number.

When configuring the slave device core built in PCIE interface, transaction layer packet (TLP) configuration message in type0 format is first converted into type1 format, and the BDF register is configured to configure identification information for the host device of a current interface. Then, a base address register (BAR) address (converted from a memory address of the host device) is configured, so that the current interface can read the memory address of the host device. Further, the command registers such as the enabling memory space register, the IO space register and the bus master control register are configured; the write maximum load length register, the maximum read request register and the strong sequence mode register are configured. At this point, the PCIE interface can realize the Switch function based on a built-in slave device core.

In one embodiment, the network interface is internally provided with a first register configured to record network protocols supported by the master device. Correspondingly, the logical interconnection module is further configured to encapsulate the data sent by the host connected to any PCIE interface using the network protocols supported by the master device, and forward encapsulated data to the master device. In one example, a user uses the master device to change one or more transmission protocols supported by the master device. The transmission protocol includes a transmission control protocol (TCP).

In one embodiment, the network interface is further configured to update the network protocols recorded in the first register according to protocol update information sent by the master device.

It should be noted that the interconnection device, some PCIE interfaces are connected to the host and some PCIE interfaces are connected to an accelerator card, and thus the communication between the host connected to one PCIE interface and the accelerator card connected to another PCIE interface may be realized. In one embodiment, any PCIE interface is configured in a root port (RP) mode and connected to an accelerator card, where the logical interconnection module is configured to forward accelerator card data sent by a PCIE interface connected to the accelerator card to the hosts connected to other PCIE interfaces, forward the data sent by the master device to the accelerator card connected to any PCIE interface, and forward the accelerator card data sent by the PCIE interface connected to the accelerator card to the master device. This forwarding process also relies on a destination address of forwarded data, and the logical interconnection module may determine whether the data is forwarded to the network interface or the PCIE interface.

In this embodiment, the network interface and each PCIE interface can be flexibly enabled and disabled, and thus before the logical interconnection module determines the transmission protocol according to current protocol information in the first register, the enabling device can further enable the network interface and disable other PCIE interfaces, so that data can be sent out through the network interface. Correspondingly, before the logical interconnection module forwards the data to the host connected to any PCIE interface through any PCIE interface, the enabling device can further enable the PCIE interface, and disable the network interface and other PCIE interfaces, so that the data can be sent out through the enabled PCIE interface. In one embodiment, the enabling device is further configured to disable the network interface and other PCIE interfaces when enabling any two PCIE interfaces of the plurality of PCIE interfaces. In one embodiment, the interconnection device further includes an enabling device. Correspondingly, the enabling device is configured to disable other PCIE interfaces when enabling the network interface and any PCIE interface.

In one embodiment, the logical interconnection module is further configured to encapsulate a network protocol message sent by the master device as a PCIE message and forward the PCIE message to any PCIE interface. Therefore, the data sent by the master device connected to the network interface to the interconnection device through the network interface may reach at least one host connected to at least one PCIE interface.

In one embodiment, the logical interconnection module is further configured to discard data without a forwarding address. That is, forwarded data includes the forwarding address, which is a destination address of the data, through which the logical interconnection module may determine whether the data is forwarded to the network interface or the PCIE interface.

In one example, the interconnection device further includes a direct memory access (DMA) management device and a DMA controller. Correspondingly, the DMA management device is configured to query memory idle information of the host connected to any PCIE interface and write data to be transmitted into a memory of a current host in a DMA mode using the DMA controller and the memory idle information, thereby realizing a direct DMA write operation between the interconnection device and the host.

The DMA management device is further configured to broadcast memory information of the interconnection device to the host connected to any PCIE interface; or store host memory information broadcasted by the host connected to any PCIE interface.

In one embodiment, the interconnection device is a field programmable gate array (FPGA) accelerator card, an application specific integrated circuit (ASIC) accelerator card or a multi-core processor.

It can be seen that in the present disclosure, the interconnection device may directly be connected to the plurality of hosts through its own PCIE interfaces to form the host cluster of mesh topologies or the host cluster of crossbar topologies. Since the PCIE interfaces of the interconnection device are configured in the EP mode, it is possible to use this interconnection device without increasing hardware costs to realize a data path between any host connected to the interconnection device and a network interface of the interconnection device, a data path between the network interface of the interconnection device and a host connected to any PCIE interface of the interconnection device, and a data path between the hosts connected to different PCIE interfaces of the interconnection device, without being connected to different hosts through network cards and networks. Of course, the interconnection device also supports other topologies.

Referring to FIG. 2, an embodiment of the present disclosure provides an interconnection network, including N interconnection devices provided in the aforementioned embodiments, and different interconnection devices are connected to the same master device. Each of N interconnection devices includes a plurality of PCIE interfaces, and each of the plurality of PCIE interfaces is connected to a host. In this embodiment, the interconnection device can be a Graphics Processing Unit (GPU), a field programmable gate array (FPGA), a neural processing unit (NPU) and a tensor processing unit (TPU). The GPU usually performs pure computing acceleration, and the FPGA can perform application acceleration processing such as computing acceleration, network acceleration and storage acceleration.

As shown in FIG. 3, it is assumed that a task needs to be accelerated, the acceleration is realized based on an interconnection device 1, an interconnection device 2 and an interconnection device 3, and all of which are connected to a same master device. The initialization process of a system is that the master device initializes PCIE interfaces of three interconnection devices respectively, and performs configuration space configuration and bus base address allocation. Three interconnection devices periodically broadcast their own free memory information to other interconnection devices through the PCIE interface. Three interconnection devices can be accelerator cards, which may realize the interconnection between different hosts without relying on network cards and networks, and form a host cluster of mesh topologies or a host cluster of crossbar topologies to realize higher performance computing.

Referring to the above embodiments, the PCIE interface of the interconnection device is a root port (RP) mode interface or an end point (EP) mode interface, and a bus address range of the PCIE interface is not less than a bus address range of a device connected to the PCIE interface. When it is configured in the EP mode, a host server can be connected to form an integration of a plurality of host servers. When it is configured in the RP mode, an accelerator card can be connected to form an artificial intelligence (AI) accelerator card system. The PCIE interface of the interconnection device includes the RP mode and the EP mode. The current RP mode and the current EP mode only support the one-to-one communication between the interconnection device with devices connected to PCIE interfaces of the interconnection device, and do not support the communication between the master device connected to the network interface of the interconnection device with the devices connected to the PCIE interfaces of the interconnection device, and do not support the communication between the devices connected to different PCIE interfaces of the interconnection device. In this embodiment, after the PCIE interface is a RP mode interface or an EP mode interface, the communication between the device connected to the network interface of the interconnection device with the devices connected to the PCIE interfaces of the interconnection device, and the communication between the devices connected to different PCIE interfaces of the interconnection device are realized. The network interface of the interconnection device provided in the embodiment of the present disclosure may be directly connected to the server, and when the interconnection device is the accelerator card, the server being directly connected to the network interface may form a system of “a host direct connection accelerator card” with the server.

Within the interconnection device, data follows a PCIE protocol. According to the present disclosure, it is possible to realize in the interconnection device a data path from bottom to top, a data path from top to bottom and a data path between host devices connected to different PCIE interfaces of the interconnection device. The transmission protocol type used by the master device may be flexibly determined according to scenario requirements. It can be seen that the interconnection device supports a full interconnection of mesh topologies, crossbar topologies, and the like, that is, any interface of the interconnection device may communicate with other interfaces of the interconnection device.

Taking the interconnection device realized by a FPGA accelerator card as an example, in the case where a PCIE interface of a FPGA is in the RP mode, a communication process between a master device connected to a network interface of the FPGA and a device connected to the PCIE interface of the FPGA and a communication process between devices connected to different PCIE interfaces of the FPGA are introduced.

In an embodiment of the present disclosure, in the embodiment, the PCIE interface of the FPGA may realize a PCIE Switch function based on a PCIE RP hard core inside the FPGA, and the utilization rate of FPGA logical resources may also be improved. When configuring the PCIE interface in the RP mode, the PCIE interface may realize the PCIE Switch function only by changing contents of the configuration space.

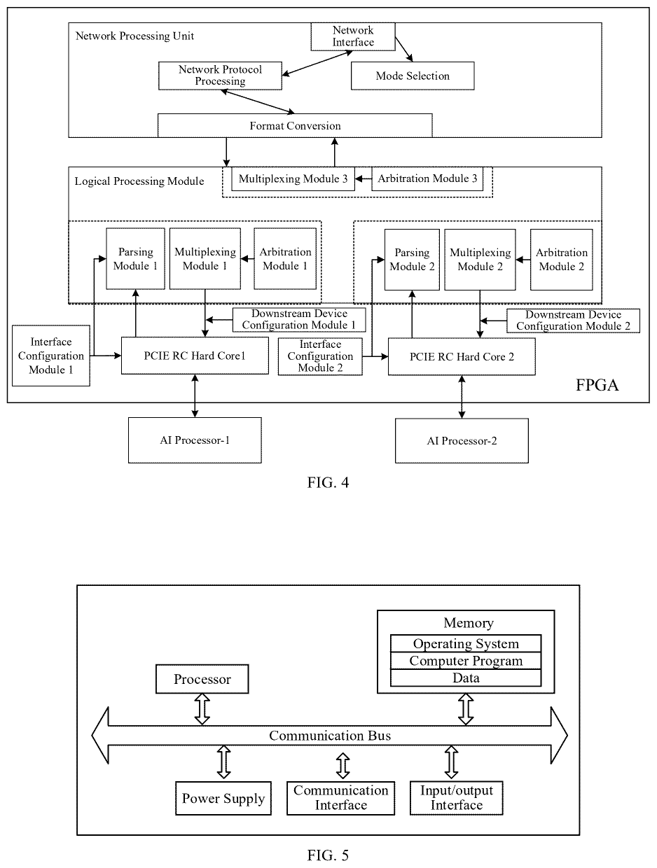

Referring to FIG. 4, it is necessary to implement the interface configuration module, the device configuration module, the logical processing module and the network module based on the PCIE RP hard core inside the FPGA. The logical processing module is provided with a parsing module, a multiplexing module and an arbitration module for the network module and two downstream PCIE interfaces, respectively. The FPGA in FIG. 4 includes two downstream PCIE interfaces, and each of the two downstream PCIE interfaces is provided with the PCIE RP hard core. Of course, the FPGA can include more or less downstream PCIE interfaces, and one downstream PCIE interface is connected to a host or an accelerator card device.

Generally, the PCIE RP hard core provides three groups of user interfaces, namely, a user receiving bus, a user sending bus and a configuration space configuration bus. The user receiving bus and the user sending bus are user interfaces for transmitting transaction layer packet (TLP) messages, and the configuration space of PCIE RP can be configured through the configuration space configuration bus, and a default register value of the configuration space is read and output to the parsing module of the logical processing module for assistance in parsing and processing. The device configuration module performs the initial configuration on the configuration spaces of two processors based on initiated configuration TLP messages, and BAR base addresses of the two processors are configured as BAR1 and BAR2 respectively. The interface configuration module performs the initial configuration on configuration spaces of two PCIE interfaces of the FPGA through configuration management bus (cfg_mgnt), and BAR base addresses of the two PCIE interfaces are configured as BAR3 and BAR4 respectively. An address range of the BAR3 is greater than or equal to an address range of the BAR1, and an address range of the BAR4 is greater than or equal to an address range of the BAR2.

It can be seen that the device configuration module is configured to initialize downstream EP devices (hosts or accelerator cards). The interface configuration module is configured to initially configure the PCIE interface. The logical processing module is configured to realize the forwarding and control of TLP messages. For a single interface, there is provided with the parsing module, the multiplexing module and the arbitration module. The parsing module parses the TLP message output by the sending bus of the PCIE RP, outputs an arbitration request according to routing information, and processes abnormal TLP messages at the same time. The arbitration module receives the arbitration request and outputs an arbitration signal to select a corresponding transmission path for the message. The multiplexing module receives data output by each path parsing module, and selects an appropriate path to send the data to the receiving bus of the PCIE RP according to the arbitration signal.

The network module is configured to handle operations related to the network interface. In this embodiment, the network module is connected to the network interface of the FPGA. The network module implements a plurality of network transmission protocols, for example, a remote direct memory access (RDMA) protocol, a TCP/IP protocol or a user-defined low latency network protocols, and the like. One of the network protocols is selected according to the mode configuration input by a user and output to the master device connected to the network interface through the network interface. As described above, the network module not only supports the PCIE protocol inside the FPGA, but also supports external protocols such as the RDMA protocol and the TCP/IP protocol, and may realize mutual conversion between the internal protocols with the external protocols. Referring to FIG. 4, when selecting an externally supported protocol, dynamic configuration can be performed through a mode selection switch. The user sends a switch register message selected based on a configuration mode through the network interface. After receiving the message, the network interface parses the message, extracts a corresponding mode selection switch value and configures the mode selection switch value to the mode selection register module. The network protocol processing module processes the corresponding network protocol according to the value of the mode selection register.

In this example, the PCIE Switch includes three paths, two of which are connected to AI processors and the other is connected to the network interface. The communication between two processors connected by two PCIE interfaces of FPGA is described below. An AI processor-1 initiates a memory access operation to an AI processor-2, and a target address is BAR2. A DMA controller of the AI processor-1 initiates an operation, and an operation message is first sent to a downstream interface PCIE RP IP-1 corresponding to FPGA PCIE Switch through a PCIE interface; the operation message is output by the PCIE RP IP-1 and then sent to a parsing module 1; and the parsing module 1 parses the TLP message and extracts corresponding information such as a destination address. If the destination address is within a routing window of a PCIE IP-2, an arbitration request of the destination address is output and sent to the arbitration module of each interface. In the current example, the destination address is the BAR2 address, and the arbitration module 2 outputs a valid arbitration enable signal, and other arbitration modules output invalid enable signals. According to the valid arbitration signal, the TLP message is sent to the receiving bus of PCIE RP IP-2, and then sent to the AI processor-2 through the PCIE interface. A DMA controller of the AI processor-2 extracts data of the TLP message and stores the data in the corresponding storage medium. If the destination address of the TLP message is not within the routing window (that is, not within the routing window of PCIE IP-2 or the routing window of the network path) or the TLP message is abnormal, the message is discarded.

It should be noted that according to this embodiment, each PCIE interface of the FPGA may be configured, so that the PCIE interface becomes a PCIE interface with the PCIE Switch function. Of course, the network interface of the FPGA can also be configured as the network interface of the Switch accordingly. Therefore, the communication between the AI processors or the hosts, and the communication between the AI processors with upstream network interfaces of the FPGA may be realized by configuring the FPGA without the help of expansion controllers or expansion cards.

It can be seen that in this embodiment, the PCIE interface of the FPGA may realize the PCIE Switch function based on the PCIE RP IP hard core of the FPGA, without using an additional PCIE Switch controller, and thus the cost is low, the implementation is simple and the utilization rate of FPGA logical resources is low. At the same time, this method may be applied to almost all FPGAs, thereby having strong portability. This method may also be extended to other PCIE processors. If PCIE interface of other PCIE processors comes with the PCIE RP IP, but does not support the PCIE Switch mode, the PCIE interface of the PCIE Switch may be realized through the PCIE RP IP to realize the Switch forwarding function. Referring to this implementation method, it is also possible to configure the PCIE interface of the PCIE Switch with the help of the PCIE EP IP hard core of the interconnection device without adding a Switch controller. However, it should be noted that in the EP mode, it is necessary to convert the configuration TLP message format for configuring the PCIE Switch from the type0 format to the type1 format. Other configuration contents may refer to the configuration of the RP mode provided in the present disclosure. The intellectual property (IP) hard core is a controller in the form of hardware modules.

An interconnection device provided in an embodiment of the present disclosure is described below, and the interconnection device described below can be mutually referenced with other embodiments described herein.

An embodiment of the present disclosure discloses an interconnection device, including: a network interface, a peripheral component interconnect express (PCIE) interface and a logical interconnection module. The network interface is internally provided with a first register and connected to a master device, and the PCIE interface is configured in a root port (RP) mode or an end point (EP) mode and connected to a host device or an accelerator card. The PCIE interface is configured to receive target data sent by a device connected to the PCIE interface. The logical interconnection module is configured to in response to determining that a destination address of the target data is within a routing address recorded in the first register (network register), convert the target data into a first message conforming to a first transmission protocol recorded in the first register, and send the first message to the master device through the network interface.

In one embodiment, the interconnection device is a field programmable gate array (FPGA) accelerator card, an application specific integrated circuit (ASIC) accelerator card or a multi-core processor.

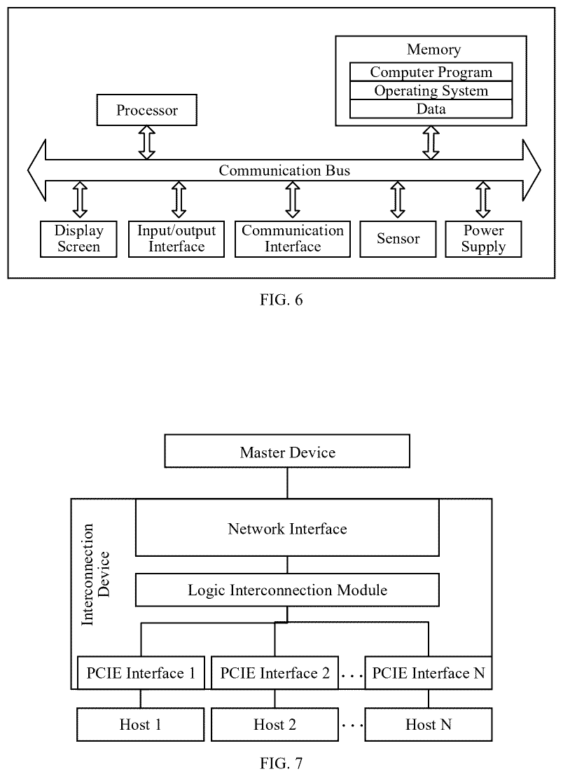

The embodiment of the present disclosure further provides an interconnection device. The above interconnection device can be either an interconnection device 1 shown in FIG. 5 or an interconnection device 2 shown in FIG. 6. FIG. 5 and FIG. 6 are both structural diagrams of interconnection devices according to an exemplary embodiment, and contents in the diagrams cannot be considered as any limitation on the scope of use of the present disclosure.

FIG. 5 is a schematic structural diagram of an interconnection device 1 provided in an embodiment of the present disclosure. The interconnection device 1 can include at least one processor, at least one memory, a power supply, a communication interface, an input/output (I/O) interface and a communication bus. The memory is configured to store computer programs, and the computer programs are loaded and executed by the processor, and cause the processor to implement related steps implemented by the logical interconnection module disclosed in any of the aforementioned embodiments.

In this embodiment, the power supply is configured to provide operating voltage for each hardware device on the interconnection device 1. The communication interface can create a PCIE-based data transmission channel between the interconnection device 1 with external devices, and a communication protocol followed by the communication interface is any communication protocol that can be applied to the technical solutions of the present disclosure, which will not be limited here. The I/O interface is configured to obtain external input data or output data to the outside world, and the interface type of the I/O interface can be selected according to actual application needs, which will not be limited here.

In addition, as a carrier of resource storage, the memory can be a read-only memory (ROM), a random access memory (RAM), a magnetic disk, an optical disk, or the like. Resources stored on the memory include an operating system, computer programs, data, and the like, and a storage mode can be temporary storage or permanent storage.

The operating system, which can be Windows Server, Netware, Unix, Linux, and the like, is configured to manage and control various hardware devices and computer programs on the interconnection device 1 to realize the operation and processing of data in the memory by the processor. The computer programs can include not only computer programs that can be used to perform the related steps realized by the aforementioned logical interconnection module, but also computer programs that can be used to perform other specific tasks. The data can include not only update information of application programs, but also developer information of the application programs.

FIG. 6 is a schematic structural diagram of an interconnection device 2 provided in an embodiment of the present disclosure. The interconnection device 2 can include but not limited to a smart phone, a tablet computer, a notebook computer, a desktop computer, or the like.

Generally, the interconnection device 2 in this embodiment includes a processor and a memory.

The processor can include one or more processing cores, for example, a 4-core processor, an 8-core processor, and the like. The processor can be implemented in at least one hardware form of a digital signal processing (DSP), a field programmable gate array (FPGA) or a programmable logic array (PLA). The processor can further include a main processor and a coprocessor. The main processor is a processor configured to process data in a wakeup state, also called a central processing unit (CPU). The coprocessor is a low-power processor configured to process data in a standby state. In some embodiments, the processor can be integrated with a graphics processing unit (GPU), which is configured to render and draw contents required to be displayed on a display screen. In some embodiments, the processor can further include an artificial intelligence (AI) processor, which is configured to process computing operations related to machine learning.

The memory can include one or more computer non-transitory readable storage media, which can be non-volatile. The memory can further include a high-speed random access memory, and a non-transitory memory, for example, one or more disk storage devices and flash storage devices. In this embodiment, the memory is at least configured to store the following computer programs. After being loaded and executed by the processor, the computer programs cause the processor to implement related steps implemented by the logical interconnection module in the interconnection device 2 disclosed in any of the aforementioned embodiments. In addition, resources stored in the memory can further include an operating system and data, and the storage mode can be temporary storage or permanent storage. The operating system can include Windows, Unix, Linux, and the like. The data can include but is not limited to update information of application programs.

In some embodiments, the interconnection device 2 can further include a display screen, an input/output (I/O) interface, a communication interface, a sensor, a power supply and a communication bus.

It can be understood by a person skilled in the art that the structure shown in FIG. 6 does not constitute a limitation on the interconnection device 2, and can include more or less components than shown in FIG. 6.

Referring to FIG. 7, the present disclosure provides an interconnection device, including a network interface, a logical interconnection module and a plurality of PCIE interfaces; where the network interface is configured to be connected to a master device; any PCIE interface of the plurality of PCIE interfaces is configured in an end point (EP) mode and connected to one of the plurality of hosts to form a host cluster of mesh topologies or a host cluster of crossbar topologies; and the logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

The interconnection device further includes a configuration device. Correspondingly, the configuration device is configured to configure the host connected to a current PCIE interface and a slave device core of the current PCIE interface according to a configuration message of any PCIE interface. The configuration device is configured to obtain configuration data of the slave device core based on the configuration message and configure the configuration data in the slave device core. The network interface is internally provided with a first register configured to record network protocols supported by the master device. Correspondingly, the logical interconnection module is further configured to encapsulate the data sent by the host connected to any PCIE interface using the network protocols supported by the master device, and forward encapsulated data to the master device. The network interface is further configured to update the network protocols recorded in the first register according to protocol update information sent by the master device.

Any PCIE interface is configured in a root port (RP) mode and connected to an accelerator card, where the logical interconnection module is configured to forward accelerator card data sent by a PCIE interface connected to the accelerator card to the hosts connected to other PCIE interfaces, forward the data sent by the master device to the accelerator card connected to any PCIE interface, and forward the accelerator card data sent by the PCIE interface connected to the accelerator card to the master device.

The interconnection device further includes an enabling device. Correspondingly, the enabling device is configured to disable other PCIE interfaces when enabling the network interface and any PCIE interface. The enabling device is further configured to disable the network interface and other PCIE interfaces when enabling any two PCIE interfaces of the plurality of PCIE interfaces.

The logical interconnection module is further configured to encapsulate a network protocol message sent by the master device as a PCIE message and forward the PCIE message to any PCIE interface. The logical interconnection module is further configured to discard data without a forwarding address.

The interconnection device further includes a direct memory access (DMA) management device and a DMA controller. Correspondingly, the DMA management device is configured to query memory idle information of the host connected to any PCIE interface and write data to be transmitted into a memory of a current host in a DMA mode using the DMA controller and the memory idle information. The DMA management device is further configured to broadcast memory information of the interconnection device to the host connected to any PCIE interface. The DMA management device is further configured to store host memory information broadcasted by the host connected to any PCIE interface.

Various embodiments in the specification are described in a progressive manner, each embodiment focuses on the difference from other embodiments, and the same and similar parts of various embodiments can be referred to each other.

Steps of a method or algorithm described in connection with the embodiments disclosed herein may be directly implemented in hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable disk, a compact disk read-only memory (CD-ROM), or any other form of nonvolatile readable storage medium known in the art.

The principles and embodiments of the present disclosure are described with the specific examples. The descriptions of the above embodiments are only for helping to understand the method and core ideas of the present disclosure. At the same time, for a person of ordinary skill in the art, according to the ideas of the present disclosure, there may be changes in specific embodiments and application scopes. In summary, contents of the specification should not be understood as limiting the present disclosure.

1. An interconnection system, comprising: an interconnection device and a plurality of hosts, wherein
the interconnection device comprises a network interface, a logical interconnection module and a plurality of peripheral component interconnect express (PCIE) interfaces;
the network interface is configured to be connected to a master device;
any PCIE interface of the plurality of PCIE interfaces is configured in an end point (EP) mode and connected to one of the plurality of hosts to form a host cluster of mesh topologies or a host cluster of crossbar topologies; and
the logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

2. The interconnection system according to claim 1, wherein the interconnection device further comprises a configuration device, wherein
the configuration device is configured to configure the host connected to a current PCIE interface and a slave device core of the current PCIE interface according to a configuration message of any PCIE interface.

3. The interconnection system according to claim 2, wherein the configuration device is configured to obtain configuration data of the slave device core based on the configuration message and configure the configuration data in the slave device core.

4. The interconnection system according to claim 1, wherein the network interface is internally provided with a first register configured to record network protocols supported by the master device; and
the logical interconnection module is further configured to encapsulate the data sent by the host connected to any PCIE interface using the network protocols supported by the master device, and forward encapsulated data to the master device.

5. The interconnection system according to claim 4, wherein the network interface is further configured to update the network protocols recorded in the first register according to protocol update information sent by the master device.

6. The interconnection system according to claim 1, wherein any PCIE interface is configured in a root port (RP) mode and connected to an accelerator card, wherein the logical interconnection module is configured to forward accelerator card data sent by a PCIE interface connected to the accelerator card to the hosts connected to other PCIE interfaces, forward the data sent by the master device to the accelerator card connected to any PCIE interface, and forward the accelerator card data sent by the PCIE interface connected to the accelerator card to the master device.

7. The interconnection system according to claim 1, wherein the interconnection device further comprises an enabling device, wherein the enabling device is configured to disable other PCIE interfaces when enabling the network interface and any PCIE interface.

8. The interconnection system according to claim 7, wherein the enabling device is further configured to disable the network interface and other PCIE interfaces when enabling any two PCIE interfaces of the plurality of PCIE interfaces.

9. The interconnection system according to claim 4, wherein the logical interconnection module is further configured to encapsulate a network protocol message sent by the master device as a PCIE message and forward the PCIE message to any PCIE interface.

10. The interconnection system according to claim 1, wherein the logical interconnection module is further configured to discard data without a forwarding address.

11. The interconnection system according to claim 1, wherein the interconnection device further comprises a direct memory access (DMA) management device and a DMA controller, wherein
the DMA management device is configured to query memory idle information of the host connected to any PCIE interface and write data to be transmitted into a memory of a current host in a DMA mode using the DMA controller and the memory idle information.

12. The interconnection system according to claim 11, wherein the DMA management device is further configured to broadcast memory information of the interconnection device to the host connected to any PCIE interface.

13. The interconnection system according to claim 11, wherein the DMA management device is further configured to store host memory information broadcasted by the host connected to any PCIE interface.

14. The interconnection system according to claim 1, wherein the interconnection device comprises a field programmable gate array (FPGA) accelerator card, an application specific integrated circuit (ASIC) accelerator card or a multi-core processor.

15. An interconnection device, comprising: a network interface, a logical interconnection module and a plurality of peripheral component interconnect express (PCIE) interfaces, wherein
the network interface is configured to be connected to a master device;
any PCIE interface of the plurality of PCIE interfaces is configured in an end point (EP) mode and connected to one of the plurality of hosts to form a host cluster of mesh topologies or a host cluster of crossbar topologies; and
the logical interconnection module is configured to forward data sent by the host connected to any PCIE interface to hosts connected to other PCIE interfaces, forward data sent by the master device to the host connected to any PCIE interface, and forward the data sent by the host connected to any PCIE interface to the master device.

16. The interconnection device according to claim 15, wherein the interconnection device further comprises a configuration device, wherein
the configuration device is configured to configure the host connected to a current PCIE interface and a slave device core of the current PCIE interface according to a configuration message of any PCIE interface.

17. The interconnection device according to claim 15, wherein the network interface is internally provided with a first register configured to record network protocols supported by the master device; and
the logical interconnection module is further configured to encapsulate the data sent by the host connected to any PCIE interface using the network protocols supported by the master device, and forward encapsulated data to the master device.

18. The interconnection device according to claim 15, wherein any PCIE interface is configured in a root port (RP) mode and connected to an accelerator card, wherein
the logical interconnection module is configured to forward accelerator card data sent by a PCIE interface connected to the accelerator card to the hosts connected to other PCIE interfaces, forward the data sent by the master device to the accelerator card connected to any PCIE interface, and forward the accelerator card data sent by the PCIE interface connected to the accelerator card to the master device.

19. An interconnection network, comprising a plurality of interconnection devices according to 15.

20. The interconnection network according to claim 19, wherein network interfaces of different interconnection devices are connected to a same master device.
